(19) United States
(12) Patent Application Publication
(10) Pub. No.: US 2026/0285495 A1
(43) Pub. Date: Sep. 24, 2026

(54) DRIVE SYSTEM FOR AN AIRCRAFT

(71) Applicant: MTU Aero Engines AG, Muenchen (DE)

(72) Inventors: Barnaby LAW, Starnberg (DE); Thomas SCHERER, Muenchen (DE); Dominik WIRTH, Muenchen (DE)

(21) Appl. No.: 19/099,085

(22) PCT Filed: Jul. 21, 2023
(86) PCT No.: PCT/DE2023/100538

§ 371 Date: Nov. 10, 2025

(30) Foreign Application Priority Data
Jul. 29, 2022 (DE) 10 2022 119 116.8

(51) Int. Cl. B64D 35/021; B64D 27/31; B64D 27/34; B64D 27/355; B64D 31/10; B64D 31/16; H02P 5/50

(52) U.S. Cl. CPC B64D 35/021; B64D 27/31; B64D 27/34; B64D 27/355; B64D 31/10; B64D 31/16; H02P 5/50

(57) ABSTRACT

A drive system (1) for an aircraft (50), including a first drive unit (11) which has a first power generator (21) for delivering first electrical power (P1) and a first propulsion unit (31) which is connected to the first power generator (21) to generate propulsion from the first electrical power (P1), and a second drive unit (12) which has a second power generator (22) for delivering second electrical power (P2) and a second propulsion unit (32) which is connected to the second power generator (22) to generate propulsion from the second electrical power (P2), and an interconnection device (40) which is configured to interconnect the first propulsion unit (31) or the first power generator (21) with the second drive unit (12) to supply power in the event of a fault condition of the first drive unit (11).

The present invention relates to a drive system for an aircraft having a drive unit.

### BACKGROUND

As will become clear in detail below, the aircraft can, in particular, be an airplane that has a multi-engine design, for example, a twin-engine airplane. Examples include designs such as the ATR-72; the aircraft can be designed for passenger and/or cargo services. This is intended to illustrate a typical application environment of the drive system, but does not initially limit the subject matter in its generality.

### SUMMARY OF THE INVENTION

It is an object of the present invention to provide an advantageous drive system.

The present invention provides a drive system (1) for an aircraft (50) having a first drive unit (11), said first drive unit having a first power generator (21) for delivering first electrical power (P1) and a first propulsion unit (31) which is connected to the first power generator (21) to generate propulsion from the first electrical power (P1), and a second drive unit (12), said second drive unit having a second power generator (22) for delivering second electrical power (P2) and a second propulsion unit (32) which is connected to the second power generator (22) to generate propulsion from the second electrical power (P2), and an interconnection device (40) which is configured to interconnect the first propulsion unit (31) or the first power generator (21) with the second drive unit (12) to supply power in the event of a fault condition of the first drive unit (11).

The present invention provides the drive system, which has a first and a second drive unit. These drive units each comprise a power generator for delivering electrical power and a propulsion unit for generating propulsion from the electrical power. A distinctive feature of the drive system is the cross-interconnection of the drive units due to an interconnection device. Said interconnection device is configured to interconnect the propulsion unit (“first propulsion unit”) of the first drive unit or the power generator (“first power generator”) of the first drive unit with the second drive unit to supply power in the event of a fault condition of the first drive unit.

As explained in detail below, depending on the fault condition, this “supply” can be carried out, for example, in the form of a transfer of electrical power from the power generator of the second drive unit (“second power generator”) to the first propulsion unit, namely in the event of a fault of the first power generator, or by a transfer of electrical power from the first power generator to the propulsion unit of the second drive unit (“second propulsion unit”), namely in the event of a fault of the first propulsion unit.

In the latter case, for example in the event of mechanical damage to the shaft or propeller of the first propulsion unit, the second drive unit must be operated at higher power until the aircraft has landed safely in order to compensate for the failure of the first propulsion unit. Due to the interconnection according to the invention, the second power generator does not have to provide this electrical power alone, which would mean that it would be oversized for normal operation; rather, the supply is provided proportionally by the first power generator. In the first fault condition, i.e., in the event of a fault of the first power generator, the first propulsion unit can continue to operate due to the proportional supply from the second power generator and thus both propulsion units can be used, for example, in an emergency landing.

Preferred embodiments can be found throughout the disclosure and are in particular the subject matter of the dependent claims. When presenting the features, a distinction is not always made in detail between apparatus and method or use aspects; in any case, the disclosure is to be read implicitly with regard to all claim categories. If, for example, the advantages of the drive system in a specific application are described, this is also to be read as a disclosure of a corresponding use or working method; furthermore, descriptions of the drive system always refer to a flying apparatus, in particular an airplane, having a corresponding drive system.

As will be explained in detail below, the interconnection in the fault condition is preferably designed to be symmetrical; i.e., it also provides an interconnection for cross-supply for the second drive unit in the event of a fault condition. Furthermore, the drive system can also comprise more than two drive units, for example a third and possibly also a fourth drive unit (possible upper limits are of a more theoretical nature and can, for example, be a maximum of 12, 10, 8 or 6 drive units). Preferably, all drive units of the drive system are interconnected via the interconnection device and, in the event of a fault condition of any of the drive units, this is configured to establish a cross-supply. Nevertheless, the following descriptions refer to the first and second drive units, and a drive system having two drive units is particularly preferred.

In general, the “configured” state of the interconnection device means that it comprises, on the one hand, corresponding physical equipment, for example a line connecting the first propulsion unit to the second power generator and/or a line connecting the first power generator to the second propulsion unit. Furthermore, the interconnection device comprises a switching unit with which this line or lines can be actively switched depending on the fault, i.e., can be switched from an unused to a used state. This switching unit can, for example, be assigned a control unit which can be, for example, part of the on-board computer or can also be designed autonomously; commands for initiating a corresponding interconnection via the switching unit depending on a fault condition or particular fault can be stored in this control unit.

In particular, the interconnection device can also be partially implemented in the control system of one or more of the motors, as a result of which the current consumption of the particular motor can be changed or prevented.

According to a preferred embodiment, the interconnection device is configured to transfer a portion of the electrical power of the second power generator (“second electrical power”) to the first propulsion unit in the event of a fault of the first power generator; see the above remarks. Alternatively, or preferably in combination therewith, in the event of a fault of the first propulsion unit, the interconnection device is configured to transfer the electrical power of the first power generator (“first electrical power”) at least proportionally or entirely to the second propulsion unit (see above).

According to a preferred embodiment, the interconnection device is configured to interconnect the second propulsion unit or the second power generator with the first drive unit to supply power in the event of a fault condition of the second drive unit. This supply can in particular be a transfer of electrical power, namely in the event of a fault of the second propulsion unit from the second power generator to the first propulsion unit and/or in the event of a fault of the second power generator from the first power generator to the second propulsion unit. A symmetrical, cross-wise interconnection is preferred.

The design of the interconnection device can also have a redundant structure in order to ensure functionality even if internal faults occur. For example, the physical equipment of the interconnection device, such as the line(s) and/or switching unit, can be provided twice.

In general, the respective power generator could also be an energy storage device, i. e. a battery system via which the electrical power is retrieved. In a preferred embodiment however, the power generators are fuel cell systems, i. e. the first power generator is thus a first fuel cell system, and the second power generator is a second fuel cell system. Each of the fuel cell systems can comprise at least one fuel cell stack; preferably each fuel cell system comprises at least two fuel cell stacks, for example three or four fuel cell stacks.

Furthermore, the power generators can also be of different types, e.g. two fuel cell systems and two battery systems. Preferably, however, they are of the same type, and particularly preferably only fuel cell systems are provided.

Cross-supply in the event of a fault condition can be particularly advantageous with regard to fuel cell systems, because the individual fuel cell stacks, if, for example, interconnected with the other propulsion unit in the event of a fault in one propulsion unit, can each be operated not at their limit, but at a more favorable operating point. For illustration, for example, if each fuel cell system has four stacks, eight stacks are available to the remaining propulsion unit in the specified fault condition, wherein, in purely mathematic terms, only six stacks, for example, would be required for operation with increased power (especially in the event of a fault condition, it may be better if the supply is not at the limit).

According to a preferred embodiment, an additional power generator is provided (for example, a battery or, in particular, a fuel cell system), wherein said power generator is interconnected with both the first and second drive units during normal operation; i.e., it supplies both the first and second propulsion units with electrical power. If one or more propulsion units are provided, the additional power generator can also supply these during normal operation. Regardless of these details, the interconnection device is configured to supply the first propulsion unit via the additional power generator in the event of a fault of the first power generator and/or to supply the second propulsion unit via the additional power generator in the event of a fault of the second power generator. Although a proportional supply is also carried out during normal operation, in the event of a fault condition the particular propulsion unit is supplied to a greater extent via the additional power generator compared to normal operation; in particular, the entire additional electrical power (of the additional power generator) is then preferably fed to the propulsion unit of which the power generator has failed.

The electrical power of the additional power generator can, in particular during normal and/or fault operation, also in each case supply electrically and/or mechanically segregated motors or motor portions (i.e., the motors or motor portions that are electrically or mechanically separated from the other motors or motor portions that are supplied by the first or second power generator) of the first and/or second propulsion unit.

The embodiment with the “additional power generator” can represent an alternative to the cross-interconnection between the drive units according to the main claim, but implements the same basic inventive idea. In the case of the additional power generator as well, namely in the event of a fault condition, electrical power used by the other drive unit during normal operation is diverted to the drive unit affected by a partial or complete failure of its own power generator. The only difference with cross-interconnection is that, during normal operation, the additional electrical power is not fed exclusively to one of the propulsion units, but is divided among the drive units. The additional power generator and its corresponding interconnection during normal operation/fault condition can thus, on the one hand, be provided as an alternative to the cross-interconnection according to the main claim; on the other hand, the two concepts can also be combined, so the additional power generator and its corresponding interconnection should also be expressly disclosed in combination with the cross-interconnection between the first and second drive units.

For example, a structure is possible to the effect that, if the fault condition of the first drive unit is a fault of the first power generator, a larger proportion of the additional electrical power is transferred to the first propulsion unit compared to normal operation. Depending on the sizing of the second and additional power generators relative to one another, either the entire additional electrical power can be fed to the first propulsion unit, or the second propulsion unit can be supplied by the additional power generator to a smaller extent compared to normal operation (additional power generator relatively oversized), or the second power generator can also supply the first propulsion unit proportionally (additional power generator relatively undersized). Alternatively or additionally, if the fault condition of the first drive unit is a fault of the first propulsion unit, the first electrical power of the first power generator and also the additional electrical power of the additional power generator can each be transferred at least proportionally to the second propulsion unit; see the advantages discussed above of the operation of the respective power generators not being carried out under full load.

In summary, the additional power generator can be provided in combination or generally also as an alternative to the cross-interconnection according to the main claim, wherein, in the latter case, all features disclosed generically for the drive system or the first/second drive unit within the scope of the present disclosure (for example, equipment with fuel cell systems, etc.) are also expressly intended to be disclosed for such a drive system having an additional power generator.

The propulsion units each preferably have an electric motor and a shaft having a propeller. During normal operation, the electric motor is operated with the electrical power of the assigned power generator; in the event of a fault condition, it can be supplied by the other power generator or the electrical power can be fed to the other electric motor. In a preferred embodiment, the electric motor, the shaft and the propeller of the first and/or second drive unit are oversized compared to their particular power generator; i.e., for example, they are designed for operation at a power that is, for example, at least 10%, 20% or 30% above the maximum power output of the particular power generator (theoretical upper limits can be, for example, 150%, 100% or 80%). The oversizing takes into account the fault “failure of the other propulsion unit,” wherein the oversizing only has to be carried out in the propulsion unit due to the interconnection device according to the invention, not in the power generator, which can result in weight advantages.

As mentioned above, the invention also relates to an aircraft having a drive system disclosed in the present case, in particular an airplane. This can, for example, have a first and a second wing (on the port and starboard sides), which wings can be arranged conventionally on a fuselage or can also be implemented in other designs. In the case of an aircraft preferably designed to accommodate a crew, the safety considerations described above can be of particular significance; additionally, the aircraft can be configured for passenger and/or cargo transport; see the remarks at the outset.

The aircraft is preferably designed in such a way that a total electrical power available for all drive units of the aircraft is smaller, in particular at least 5%, at least 15%, or at least 25% smaller, than the product of a minimum electrical power per drive unit that is required in the event of a failure of at least one other drive unit to at least temporarily compensate for the failure at a drive unit that has not failed and of the number of drive units on the aircraft.

The power can preferably be controlled such that each of the drive units of the aircraft has the minimum power sequentially or that this power is sequentially available at each of the drive units.

Alternatively or additionally, the power can be controlled so that the minimum power is available to all drive units except at least one drive unit simultaneously.

In particular, the minimum power per drive unit is greater than an electrical power per drive unit in a comparable normal operation, for example in a comparable flight phase, without a failure of a drive unit.

The first and second drive units of the drive system can preferably be arranged on different wings, so that in the event of a failure, the cross-supply, such as the electrical power transfer, takes place, for example, from one side of the aircraft to the other. Alternatively, the drive units can also be arranged on the same wing, in which case further drive units are preferably arranged on the other wing.

The aircraft can have exactly two, exactly four or exactly six drive units. Half the number of drive units can be arranged on a first wing of the airplane and half the number of drive units can be arranged on a second wing of the airplane.

In other embodiments, the airplane can also comprise an odd number of drive units, e.g., exactly three. One or more drive units can be arranged in regions outside a wing, e.g., on the fuselage.

The invention also relates to a method for operating a drive system or aircraft disclosed in the present case, in particular an airplane, wherein, in the event of a fault condition, the first propulsion unit or the first power generator is interconnected with the second drive unit. In particular, in the event of a fault of the first power generator, the second electrical power can be transferred proportionally to the first propulsion unit and/or in the event of a fault of the first propulsion unit, the first electrical power can be transferred at least proportionally to the second distribution unit; see above for further details.

Furthermore, the invention relates to the use of a drive system or aircraft described in the present case in such a method.

### BRIEF DESCRIPTION OF THE DRAWINGS

In the following, the invention is explained in more detail using exemplary embodiments, wherein the individual features can also be substantial to the invention in other combinations within the scope of the independent claims.

In the drawings, in detail:

FIG. 1 is a schematic representation of a drive system having a first and a second drive unit;

FIG. 2A, B show various faults of the first drive unit of the drive system according to FIG. 1;

FIG. 3 is a schematic representation of an aircraft having a drive system according to FIG. 1.

FIG. 4 shows a drive system having an additional power generator.

### DETAILED DESCRIPTION

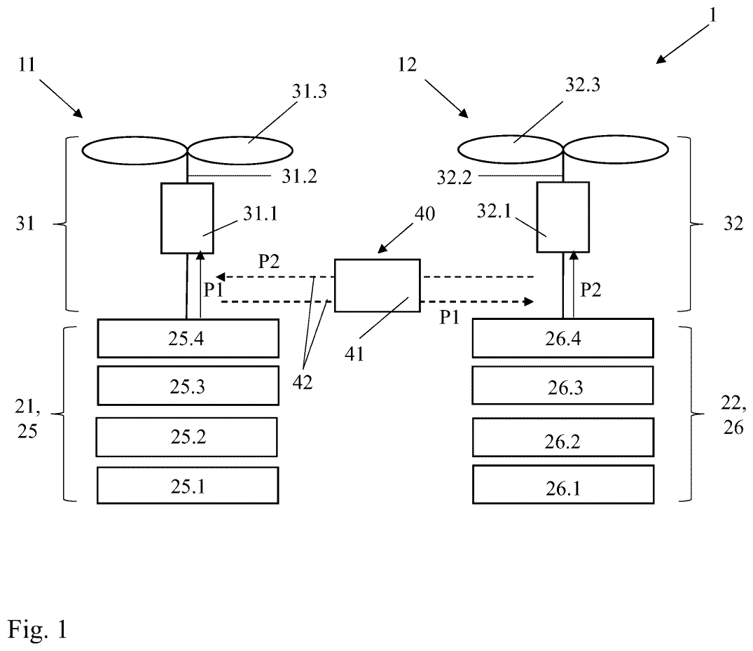

FIG. 1 shows a drive system 1 having a first drive unit 11 and a second drive unit 12. The first drive unit 11 comprises a first power generator 21 for delivering first electrical power P1 and a first propulsion unit 31 for generating propulsion therefrom. Likewise, the second drive unit 12 comprises a second power generator 22 for delivering a second electrical power P2 and a second propulsion unit 32 that generates propulsion therefrom.

The power generators 21, 22 are provided in the form of a first fuel cell system 25 and a second fuel cell system 26. Each of the fuel cell systems 25, 26 has a plurality of fuel cell stacks 25.1-25.4, 26.1-26.4. The propulsion units 31, 32 each comprise an electric motor 31.1, 32.1 and a shaft 31.2, 32.2 having a propeller 31.3, 32.3.

The drive system further comprises an interconnection device 40, with which the electrical power P1 and/or P2 can be diverted from the first to the second and/or from the second to the first drive unit. For this purpose, the interconnection device 40 comprises, on the one hand, corresponding lines 42 and, on the other hand, an assigned switching unit 41, with which the particular line can be switched to active if required (shown here schematically and represented as inactive by the dashed line).

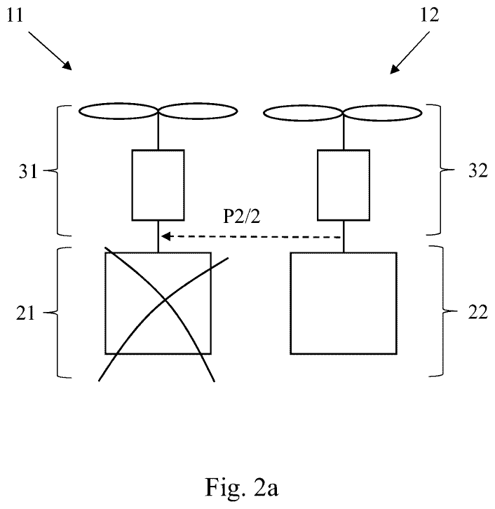

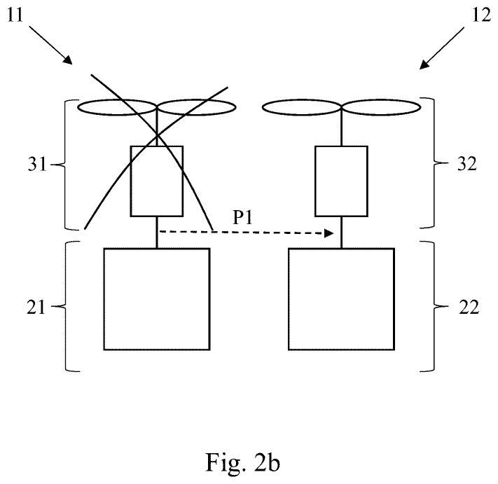

FIG. 2A illustrates a first fault condition of the first drive unit, namely a failure of the first power generator 21. In this case, the second electrical power P2 of the second power generator 22, in the present case approximately half, is transferred proportionally from the second to the first drive unit and the first propulsion unit 31 is thus further operated.

By contrast, the fault condition shown in FIG. 2B relates to a failure of the first propulsion unit 31 (e.g., mechanical damage to the propeller/shaft), wherein the first power generator 21 is still intact. To compensate for the failure of the first drive unit 11, the propulsion unit 32 of the second drive unit 12 must be operated with higher power, for which it is additionally supplied with the first electrical power P1 of the first power generator 21. Since the two power generators 21, 22 then supply the second propulsion unit 32 together, they can each be operated below their maximum load capacity.

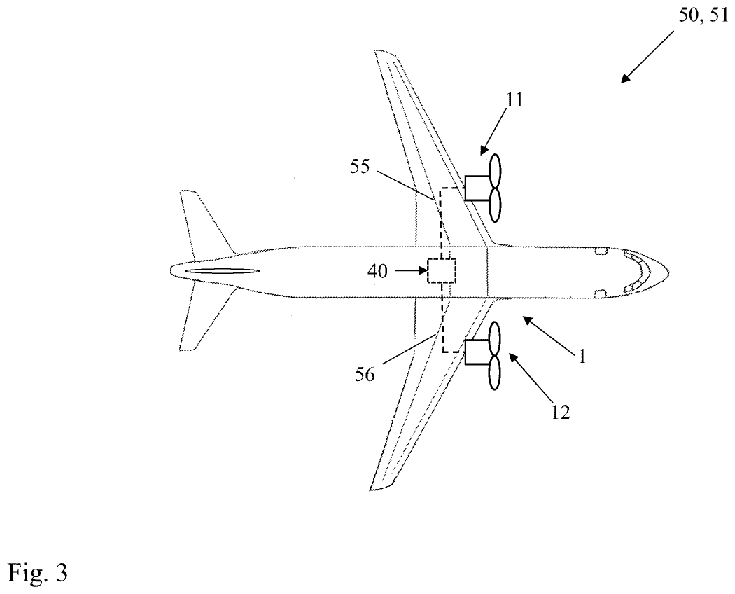

FIG. 3 shows a schematic representation of an aircraft 50, namely an airplane 51. This has a first wing 55 and a second wing 56, and is further equipped with a drive system 1 as described above. In this example, the first drive unit 11 is arranged on the first wing 55 and the second drive unit 12 is arranged on the second wing 56.

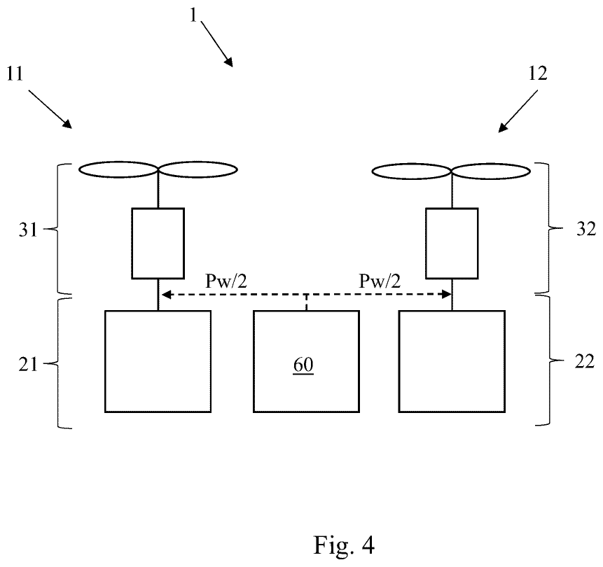

FIG. 4 shows a drive system 1 which in its basic structure corresponds to that according to FIG. 1; i.e., it has a first and a second drive unit 11, 12; see above for further details. The first drive unit 11 has a first propulsion unit 31 and a first power generator 21; the second drive unit 12 has a second propulsion unit 32 and a second power generator 22. In contrast to the variant described above, this drive system 1 has an additional power generator 60 which delivers an additional electrical power Pw. In the normal state/normal operation shown in FIG. 4, this is fed proportionally to the first and second propulsion units 31, 32, thus serving to supply both drive units 11, 12. If, in the event of a fault condition, the first or second power generator 21, 22 fails, the additional electrical power Pw can then be amplified by means of the interconnection device (not shown here) or can also be fed entirely to the propulsion unit of the drive unit affected by this failure.

### LIST OF REFERENCE SIGNS

Drive system 1
First drive unit 11
Second drive unit 12
Power generator 21
Power generator 22
First fuel cell system 25
Fuel cell stacks 25.1-25.4
Second fuel cell system 26
Fuel cell stacks 26.1-26.4
First propulsion unit 31
Electric motor 31.1
Shaft 31.2
Propeller 31.3
Second propulsion unit 32
Electric motor 32.1
Shaft 32.2
Propeller 32.3
Interconnection device 40
Switching unit 41
Lines 42
Aircraft 50
Airplane 51
First wing 55
Second wing 56
Additional power generator 60
First electrical power P1
Second electrical power P2
Additional electrical power Pw

1-15. (canceled)

16: A drive system for an aircraft, the drive system comprising:
a first drive unit having a first power generator for delivering first electrical power and a first propulsion unit connected to the first power generator to generate propulsion from the first electrical power, and
a second drive unit having a second power generator for delivering second electrical power and a second propulsion unit connected to the second power generator to generate propulsion from the second electrical power; and
an interconnector configured to interconnect the first propulsion unit or the first power generator with the second drive unit to supply power in the event of a fault condition of the first drive unit.

17: The drive system as recited in claim 16 wherein the interconnector is configured to transfer the second electrical power of the second power generator proportionally to the first propulsion unit if the fault condition of the first drive unit is a fault of the first power generator.

18: The drive system as recited in claim 16 wherein the interconnector is configured to transfer the first electrical power of the first power generator at least proportionally to the second propulsion unit if the fault condition of the first drive unit is a fault of the first propulsion unit.

19: The drive system as recited in claim 16 wherein the interconnector is configured to interconnect the second propulsion unit or the second power generator with the first drive unit to supply power in the event of a fault condition of the second drive unit.

20: A drive system for an aircraft, the drive system comprising:
a first drive unit having a first power generator for delivering first electrical power and a first propulsion unit connected to the first power generator to generate propulsion from the first electrical power, and
a second drive unit having a second power generator for delivering second electrical power and a second propulsion unit connected to the second power generator to generate propulsion from the second electrical power; and
an additional power generator designed to deliver additional electrical power fed proportionally to the first and second propulsion unit during normal operation, and
an interconnector configured to transfer the additional electrical power of the additional power generator to the first propulsion unit in the event of a fault of the first power generator.

21: The drive system as recited in claim 16 wherein the first or the second power generator are each fuel cell systems.

22: The drive system as recited in claim 21 wherein the fuel cell systems have at least two fuel cell stacks.

23: The drive system as recited in claim 16 wherein the first and second propulsion units each have an electric motor and a shaft having a propeller.

24: The drive system as recited in claim 23 wherein the electric motor, the shaft and the propeller are oversized with respect to the power generator.

25: An aircraft comprising:
the drive system as recited in claim 16, wherein a power of the first and second drive units during a failure is greater than the first or second electrical power respectively in a respectively comparable normal operation without a failure of the first or second drive unit.

26: The aircraft as recited in claim 25 wherein the aircraft is an airplane having a first and a second win, wherein the first drive unit is arranged on the first wing and the second drive unit is arranged on the second wing, thus supply is distributed from one side of the aircraft to the other using the interconnector in the event of a fault condition.

27: The aircraft as recited in claim 25 wherein the aircraft is an airplane having a first and a second wing, wherein the first drive unit and the second drive are arranged on the first wing.

28: A method for operating the drive system as recited in claim 16, the method comprising interconnecting the first propulsion unit or the first power generator with the second drive unit to supply power in the event of a fault condition of the first drive unit.

29: The method as recited in claim 28 wherein the second electrical power of the second power generator is transferred proportionally to the first propulsion unit if the fault condition of the first drive unit is a fault of the first power generator.

30: The method as recited in claim 28 wherein the first electrical power of the first power generator is at least proportionally transferred to the second propulsion unit if the fault condition of the first drive unit is a fault of the first propulsion unit.
